(19) United States
(12) Patent Application Publication
(10) Pub. No.: US 2002/0188517 A1
(43) Pub. Date: Dec. 12, 2002

(54) Using a communications network in arranging shipment of goods according to a buyer's preferences

(75) Inventors: Dwip N. Banerjee, Austin, TX (US); Rabindranath Dutta, Austin, TX (US)

Correspondence Address: Paul D Heydon, Suite 300 909 NE Loop 410, San Antonio, TX, 78209, US

(73) Assignee: International Business Machiness Corporation

(21) Appl. No.: 09/875,871

(22) Filed: Jun. 7, 2001

(51) Int. Cl. G06F 17/60

(52) U.S. Cl. 705/26

(57) ABSTRACT

The present invention is a system and method for using a communications network in arranging transportation of goods according to a buyer's preferences. The invention uses a computer system and network, and may use server computers, and a buyer's client computer. The invention involves receiving a request or order to purchase goods, along with a request for shipment of the goods via a buyer's preferred delivery agency, and fulfilling the request or order by shipping said goods via said buyer's preferred delivery agency. One aspect of the present invention is a method for using a communications network in arranging shipment of goods according to a buyer's preferences. Another aspect of the present invention is a system for executing the method of the present invention. A third aspect of the present invention is as a set of instructions on a computer-usable medium, or resident in a computer system, for executing the method of the present invention.

### FIELD OF THE INVENTION

The present invention relates generally to transportation of goods, and more particularly to methods and systems using a communications network in arranging shipment of goods according to a buyer's preferences.

### BACKGROUND OF THE INVENTION

Electronic commerce methods in use today typically give the buyer of goods relatively little choice in how the goods will be transported from seller to buyer, and relatively little control over the shipping cost. Typically the seller decides on a few delivery methods or delivery agencies that will be offered as options to the buyer. The actual shipping cost may be hidden from the buyer, or difficult for the buyer to determine.

U.S. Pat. No. 6,092,053 (Boesch, et al., Jul. 18, 2000) discloses a “consumer information server” that stores consumers' information, including some shipping information, and provides information to merchants. It discloses, at column 10, a process of prompting the consumer to provide information demanded by a merchant, and to choose among options approved by a merchant, using a “directory of addresses, shippers, shipping methods, credit cards, and other information options.”

U.S. Pat. No. 6,064,981 (Barni et al., May 16, 2000) discloses an online auction to negotiate cargo rates in an online, anonymous manner; it discloses the selection of transportation by sea, land, or air.

International Application No. PCT/US00/02888, International Publication No. WO 00/46718 (Tangkilisan, published Aug. 10, 2000) discloses a system that provides a bidding environment for multiple freight forwarders; a consumer with shipping needs provides shipment information only once to a service provider.

Electronic commerce methods in use today typically give the buyer of goods relatively little choice or control regarding shipment of the goods. Thus there is a need for systems and methods that provide a way for a buyer to specify the buyer's preferred delivery agency as the means for shipping goods; there is a need for systems and methods that provide a way for a buyer to negotiate shipping charges with the buyer's preferred delivery agency, and to pay the buyer's preferred delivery agency directly.

### SUMMARY OF THE INVENTION

A buyer of goods in electronic commerce may enjoy economic benefits by specifying the buyer's preferred delivery agency as the means for shipping goods, negotiating shipping charges with the buyer's preferred delivery agency, and paying the buyer's preferred delivery agency directly. Both buyer and delivery agency could benefit by an arrangement where a single delivery agency's services were used to satisfy all or most of a buyer's shipping requirements, especially if the buyer were a business or institution. The present invention is a method and system for implementing such an arrangement.

The invention involves a seller receiving a request or order to purchase goods, along with a request for shipment of the goods via a buyer's preferred delivery agency, and fulfilling the request or order by shipping the goods via the buyer's preferred delivery agency. For example, the above-mentioned method might be initiated by transmitting, from the seller's server to the buyer's client computer, an indication that shipment of the goods may be accomplished via the buyer's preferred delivery agency, and transmitting to the buyer's client computer the price of the goods, without added shipping costs. The above-mentioned method might further involve transmitting from the seller's server computer, to the buyer's preferred delivery agency, shipping information regarding the goods. The shipping information would include an identifier of the goods, and a time and a place for pick-up of the goods by the buyer's preferred delivery agency. The seller would make the goods available for pick-up by the buyer's preferred delivery agency.

### BRIEF DESCRIPTION OF THE DRAWINGS

A better understanding of the present invention can be obtained when the following detailed description is considered in conjunction with the following drawings. The use of the same reference symbols in different drawings indicates similar or identical items.

FIG. 1 illustrates a simplified example of a computer system capable of performing the present invention.

FIG. 2 is a high-level block diagram illustrating an example of a system for arranging shipment of goods according to a buyer's preferences, according to the teachings of the present invention.

FIG. 3 is a block diagram illustrating communications among computers in an exemplary system such as the exemplary system of FIG. 2, according to the teachings of the present invention.

FIG. 4 is a flow chart illustrating an example of a process for arranging shipment of goods according to a buyer's preferences, according to the teachings of the present invention.

FIG. 5 is a flow chart illustrating another example of a process for arranging shipment of goods according to a buyer's preferences, according to the teachings of the present invention.

FIG. 6 is a flow chart illustrating examples of two related processes for arranging shipment of goods according to a buyer's preferences, that may run on two computers coupled by a communications network, according to the teachings of the present invention.

### DETAILED DESCRIPTION

The examples that follow involve the use of computers and a network. The present invention is not limited as to the type of computer on which it runs, and not limited as to the type of network used. To simplify matters, the diagrams and examples that follow generally involve only two server computers and one network. However, more than two servers and more than one network may be used.

The examples that follow involve networked systems using a client/server architecture. A “client” is a member of a class or group that uses the services of another class or group to which it is not related. In the context of a computer network, such as the Internet, a client is a process (i.e., roughly a program or task) that requests a service which is provided by another program. The client process uses the requested service without having to “know” any working details about the other program or the service itself. In networked systems, a client is usually a computer that accesses shared network resources provided by another computer (i.e., a server). A “server” is typically a remote computer system which is accessible over a communications medium such as the Internet. The server scans and searches for information sources. Based upon such requests by the user, the server presents filtered electronic information to the user as server responses to the client process. The client process may be active in a second computer system, and communicate with one another over a communications medium that allows multiple clients to take advantage of the information-gathering capabilities of the server. Clients and servers may, for example, communicate with one another using the functionality provided by a Hyper Text Transfer Protocol (HTTP). The World Wide Web (WWW) or, simply, the “web,” includes all servers adhering to this protocol, which are accessible to clients via a Universal Resource Location (URL). Internet services can be accessed by specifying Universal Resource Locators that have two basic components: a protocol to be used and an object pathname. For example, the Universal Resource Locator address, “http://www.uspto.gov” (i.e., the “home page” for the U.S. Patent and Trademark Office), specifies a hypertext transfer protocol (“http”) and a pathname of the server (“www.uspto.gov”). The server name is associated with a unique numeric value (TCP/IP address). Active within the client is a first process, known as a “browser”, that establishes the connection with the server, and presents information to the user. The server itself executes corresponding server software that presents information to the client in the form of HTTP responses. The HTTP responses correspond to “web pages” constructed from a Hypertext Markup Language (HTML), or other server-generated data. A “web page” (also referred to by some designers simply as a “page”) is a data file written in a hyper-text language that may have text, graphic images, and even multimedia objects such as sound recordings or move video clips associated with that data file. The web page can be displayed as a viewable object within a computer system. A viewable object can contain one or more components such as spreadsheets, text, hotlinks, pictures, sound, and video objects. A web page can be constructed by loading one or more separate files into an active directory or file structure that is then displayed as a viewable object within a graphical user interface. When a client workstation sends a request to a server for a web page, the server first transmits (at least partially) the main hypertext file associated with the web page, and then loads, either sequentially or simultaneously, the other files associated with the web page. A given file may be transmitted as several separate pieces via TCP/IP protocol. The constructed web page is then displayed as a viewable object on the workstation monitor. A web page may be “larger” than the physical size of the monitor screen, and devices such as graphical user interface scroll bars can be utilized by the viewing software (i.e., the browser) to view different portions of the web page. Most text displayed by a web browser is formatted using standard HTML. An HTML file is a text file that contains both the text to be displayed and markup tags that describe how the text should be formatted by the web browser. The HTML markup tags support basic text formatting, such as paragraph breaks, bullet lists, tables, graphs, charts, and so forth. In addition to these basic text formatting tags, HTML provides tags defining graphical user interface components. HTML also can be used to display well known graphical user interface components such as radio buttons, check boxes, scrolling lists of selectable text, and various other such components at the web browser itself. In an open network, such as the Internet, establishing a secure connection is required in order to prevent a third party from viewing sensitive information, such as personal data or financial transactions. Secure connections can be established between a browser running on a typical client machine, or on a network computer, and a web server using a security protocol such as Secure Sockets Layer (SSL).

Various implementation methods may be used for the present invention. The examples that follow involve information that is communicated between computers; this information could be in hypertext markup language (HTML), or extensible markup language (XML), or some other language or protocol could be used.

XML provides a way of containing and managing information that is designed to handle data exchange among various data systems. Thus it is well-suited to implementation of the present invention. Reference is made to the book by Elliotte Rusty Harold and W.

Scott Means, XML in a Nutshell (O'Reilly & Associates, 2001). As a general rule XML messages use “attributes” to contain information about data, and “elements” to contain the actual data. Reference is made to a white paper by Transentric, a division of Union Pacific Corporation, TranXML [TM]: The Common Vocabulary for Transportation Data Exchange (2001), available at http://www.transentric.com. The paper describes TranXML [TM], a markup language developed for data exchange in the transportation industry. The data format is readable by both humans and machines. These XML structures are open source software, freely available under a General Public License, and they include XML structures for messages relating to tracing shipped goods (e.g. a Shipment Status Message).

The present invention may be implemented in whole or in part by using e-mail, and well-known standards such as Simple Mail Transfer Protocol (SMTP). Regarding such standards, reference is made to the following document: Jonathan B. Postel, Request for Comments (RFC) # 821, Simple Mail Transfer Protocol, 1982. An e-mail implementation may use Transmission Control Protocol (TCP). An e-mail implementation could be used to avoid possible firewall and security issues in corporate environments. E-mail might be a convenient way for a buyer to forward shipping information to the buyer's preferred delivery agency. For example, a client application may send messages to a message queue of a Post Office Protocol (POP) server for a delivery agency. The messages may contain shipping information in any chosen format that sender and receiver understand. An application may run on a delivery agency's server, periodically checking the message queue for new messages containing shipping information, received from buyers or sellers. This application may parse pertinent shipping information from the e-mail messages.

The following are definitions of terms used in the description of the present invention and in the claims:

“Agency” or “delivery agency” means any person or organization who delivers, or assists in delivering, goods to a buyer; some examples are an air cargo company, courier service, delivery service, freight forwarder, parcel service, post office, or a provider of services for delivery operations.

“Computer-usable medium” means any carrier wave, signal or transmission facility for communication with computers, and any kind of computer memory, such as floppy disks, hard disks, Random Access Memory (RAM), Read Only Memory (ROM), CD-ROM, flash ROM, non-volatile ROM, and non-volatile memory.

“Buyer” means any person or organization who buys goods.

“Seller” means any person or organization who sells goods, including a manufacturer, wholesaler, or retailer.

“Storing” data or information, using a computer, means placing the data or information, for any length of time, in any kind of computer memory, such as floppy disks, hard disks, Random Access Memory (RAM), Read Only Memory (ROM), CD-ROM, flash ROM, non-volatile ROM, and non-volatile memory.

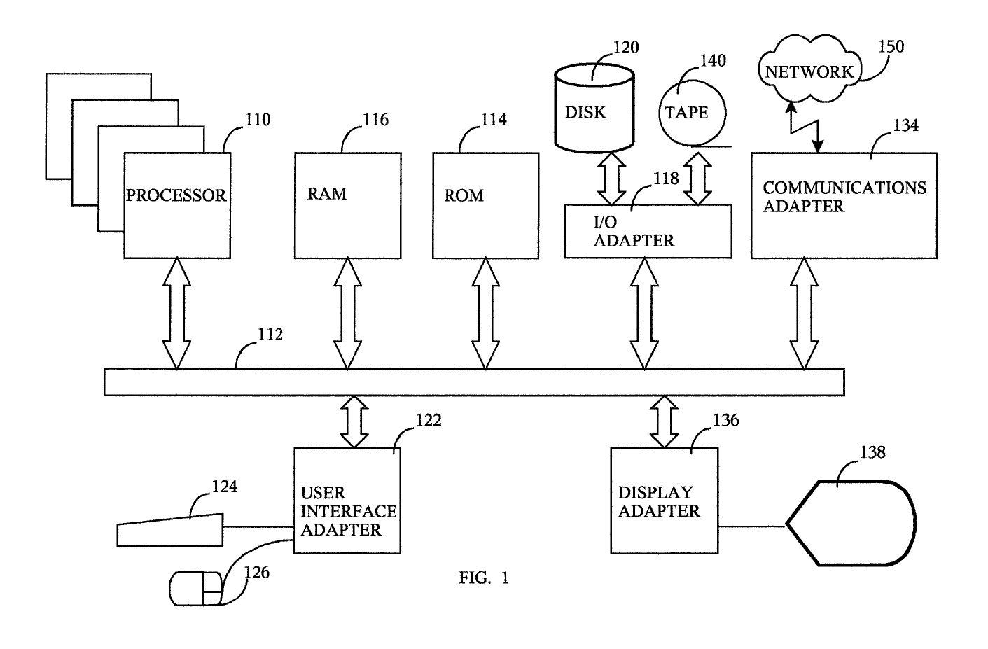

FIG. 1 illustrates a simplified example of an information handling system that may be used to practice the present invention. The invention may be implemented on a variety of hardware platforms, including personal computers, workstations, servers, and embedded systems. The computer system of FIG. 1 has at least one processor 110. Processor 110 is interconnected via system bus 112 to random access memory (RAM) 116, read only memory (ROM) 114, and input/output (I/O) adapter 118 for connecting peripheral devices such as disk unit 120 and tape drive 140 to bus 112, user interface adapter 122 for connecting keyboard 124, mouse 126 or other user interface devices to bus 112, communication adapter 134 for connecting the information handling system to a data processing network 150, and display adapter 136 for connecting bus 112 to display device 138. Communication adapter 134 may link the system depicted in FIG. 1 with hundreds or even thousands of similar systems, or other devices, such as remote printers, remote servers, or remote storage units. The system depicted in FIG. 1 may be linked to both local area networks (sometimes referred to as Intranets) and wide area networks, such as the Internet.

While the computer system described in FIG. 1 is capable of executing the processes described herein, this computer system is simply one example of a computer system. Those skilled in the art will appreciate that many other computer system designs are capable of performing the processes described herein.

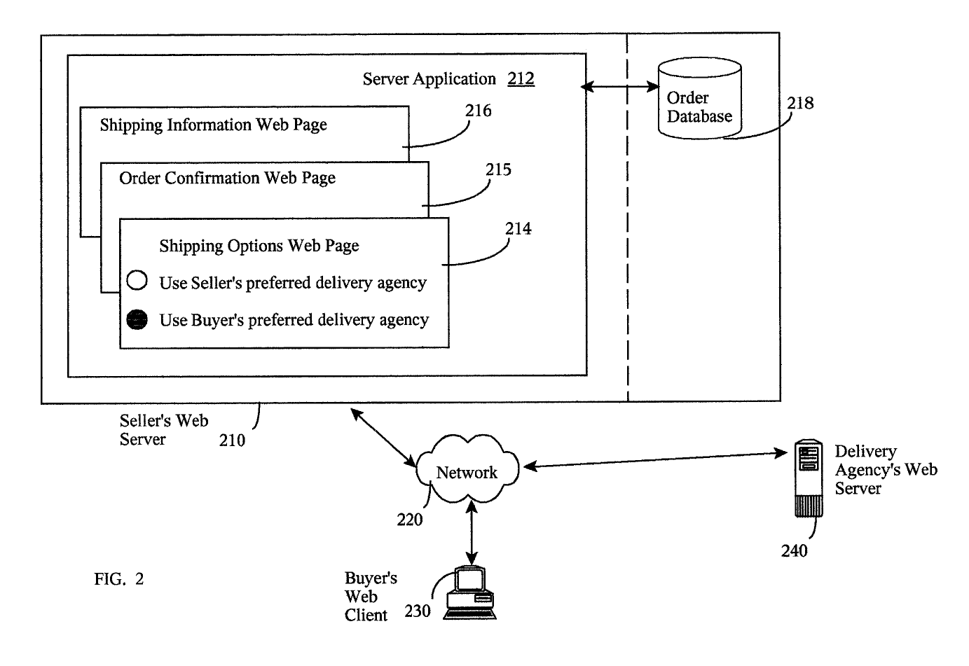

FIG. 2 is a high-level block diagram illustrating an example of a system for arranging shipment of goods according to a buyer's preferences, according to the teachings of the present invention. In this example, buyer's web client 230, a seller's web server 210 and delivery agency's web server 240 are coupled through a network 220. Seller's web server 210 and delivery agency's web server 240 and buyer's web client 230 may be implemented as conventional computer systems. Alternatively, the buyer's web client 230 can be implemented as a network computer or thin client device. Buyer's web client 230 may also be a laptop computer, a hand-held computing device, a personal digital assistant (PDA), or a mobile telephone. Buyer's web client 230 may use a wireless communications network, and may use Wireless Application Protocol (WAP), for example. Software application programs for implementing the present invention run on seller's web server 210, delivery agency's web server 240, and buyer's web client 230. The server portion of the application software of the present invention is shown as server application 212. In addition, web server 210 includes or has access to an order database (or information store) 218 for storing and managing order information. As indicated by the dashed line in web server 210, order database 218 may be incorporated into web server 210 or may be operated as a database system independent of, but accessible to, web server 210. Software application programs running on buyer's web client 230 may include a graphical user interface, a browser and purchasing software.

Seller's web server 210 may include various web pages, some of which are shown as shipping options web page 214, order confirmation web page 215, and shipping information web page 216. Shipping options web page 214 is an example of one way to transmit, from Seller's web server 210 to buyer's web client 230, an indication that shipment of goods may be accomplished via buyer's preferred delivery agency. Web pages like shipping options web page 214 are examples of ways for Seller's web server 210 to receive, from buyer's web client 230, a request to purchase goods, along with a request for shipment of goods via a buyer's preferred delivery agency. A darkened circle on shipping options web page 214 shows input from the buyer, requesting shipment of goods via a buyer's preferred delivery agency. Order confirmation web page 215 is an example of one way to transmit, from Seller's web server 210, a confirmation that Seller's web server 210 has generated an order to buy the goods, with shipment of the goods via the buyer's preferred delivery agency. Order confirmation would be sent from Seller's web server 210 to buyer's web client 230. Shipping information web page 216 is an example of one way to transmit, from Seller's web server 210, shipping information regarding the goods, the shipping information including an identifier of the goods, and a time and a place for pick-up of the goods by the buyer's preferred delivery agency. An order number or a tracking number are examples of an identifier. The shipping information may be transmitted from Seller's web server 210 to buyer's web client 230, or to delivery agency's web server 240, or both.

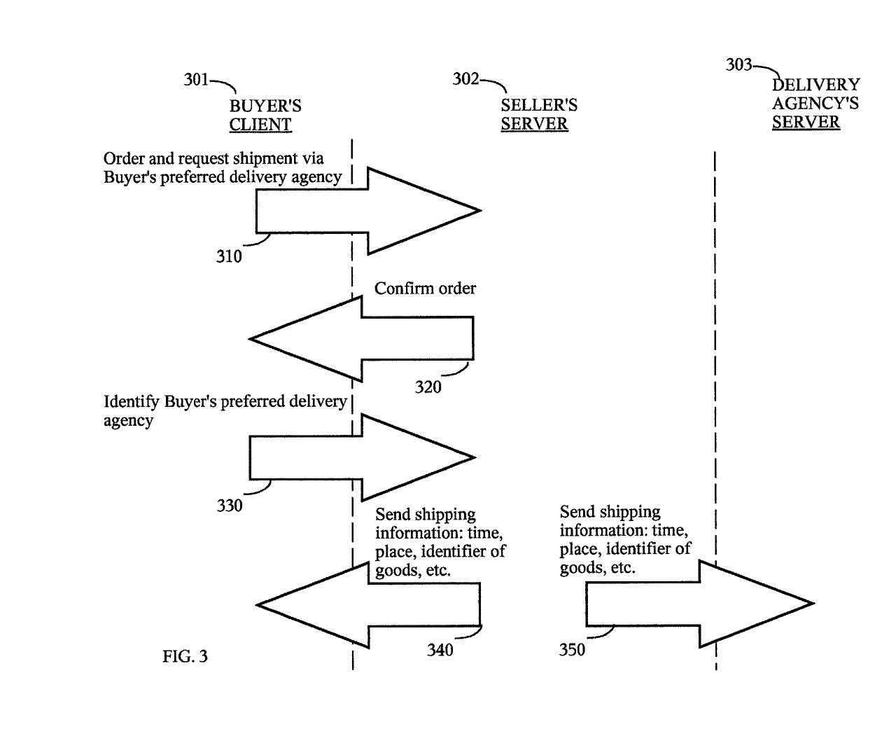

FIG. 3 is a block diagram illustrating communications among computers, namely buyer's client 301, seller's server 302, and delivery agency's server 303, in an exemplary system such as the exemplary system of FIG. 2, according to the teachings of the present invention. Beginning at the top left of the diagram, at block 310, buyer's client 301 sends to seller's server 302 a message to order goods and request shipment of the goods via Buyer's preferred delivery agency. At block 320, seller's server 302 sends to buyer's client 301 a message to confirm the order. At block 330, buyer's client 301 sends to seller's server 302 a message to identify Buyer's preferred delivery agency. At block 340, seller's server 302 sends to buyer's client 301 some shipping information, including an identifier of the goods, and a time and a place for pick-up of the goods by the buyer's preferred delivery agency. At block 350, seller's server 302 sends to delivery agency's server 303 shipping information, including an identifier of the goods, and a time and a place for pick-up of the goods by the buyer's preferred delivery agency.

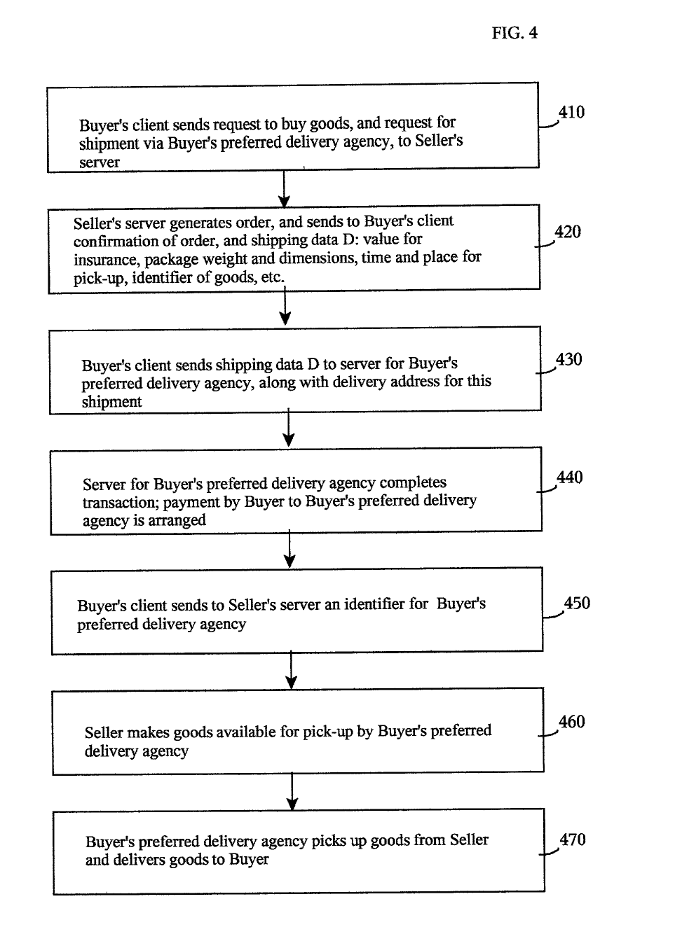

FIG. 4 is a flow chart illustrating an example of a process for arranging shipment of goods according to a buyer's preferences. According to the teachings of the present invention, other examples are possible, which might have steps in a different order, or might omit some steps. Beginning at the top of the diagram, at block 410, Buyer's client sends a request to buy goods, and a request for shipment of the goods via Buyer's preferred delivery agency, to Seller's server. At block 420, Seller's server generates an order for the goods, and sends to Buyer's client confirmation of the order, and some shipping information, shown as “shipping data D”. Shipping data D may include a value of the goods for insurance purposes, package weight and dimensions, time and place for pick-up, and an identifier of the goods. An order number or a tracking number are examples of an identifier. At block 430, Buyer's client sends some shipping information, shown as “shipping data D” to a server for Buyer's preferred delivery agency, along with a delivery address for this shipment. At block 440, a server for Buyer's preferred delivery agency completes the transaction; payment by Buyer to Buyer's preferred delivery agency is arranged. For example, this would involve a server for Buyer's preferred delivery agency receiving information (such as authorization to charge a certain financial account), to arrange payment of shipping costs by the buyer to the buyer's preferred delivery agency. At block 450, Buyer's client sends to Seller's server an identifier for the Buyer's preferred delivery agency. At block 460, seller makes goods available for pick-up by Buyer's preferred delivery agency. At block 470, Buyer's preferred delivery agency picks up the goods from Seller and delivers the goods to Buyer, and the process terminates.

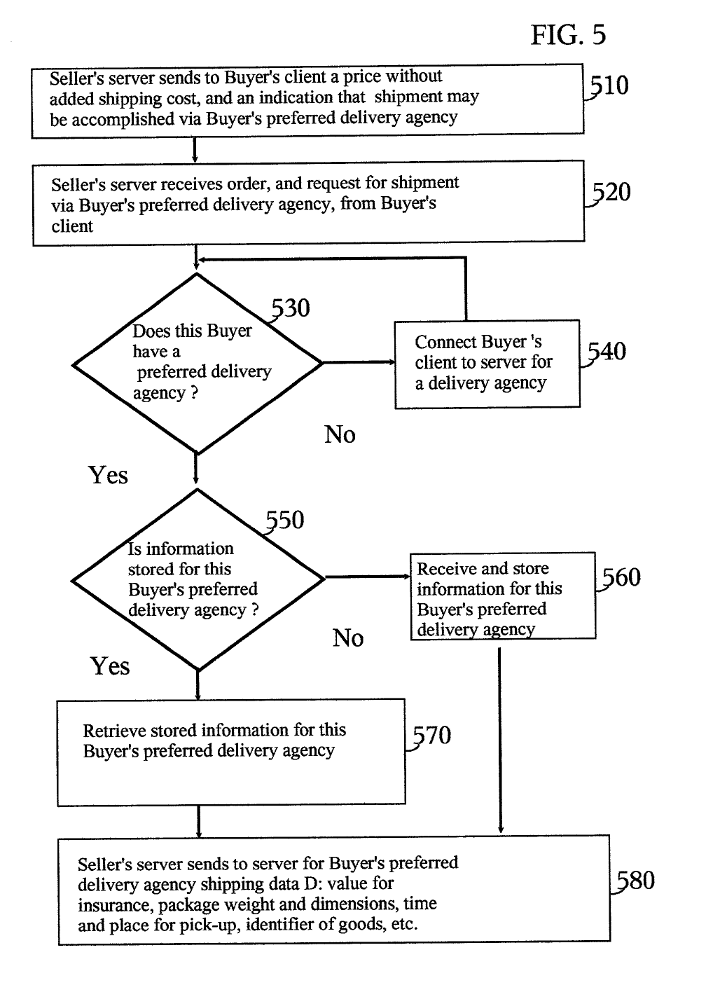

FIG. 5 is a flow chart illustrating another example of a process for arranging shipment of goods according to a buyer's preferences. According to the teachings of the present invention, other examples are possible, which might have steps in a different order, or might omit some steps. At block 510, Seller's server sends to Buyer's client a price for some goods without added shipping cost, and an indication that shipment of the goods may be accomplished via Buyer's preferred delivery agency. At block 520, Seller's server receives order for goods, and request for shipment of the goods via Buyer's preferred delivery agency, from Buyer's client. At decision 530, if this Buyer already has a preferred delivery agency, the “Yes” branch is taken, leading to decision 550. On the other hand, at decision 530, if this Buyer does not already have a preferred delivery agency, the “No” branch is taken, leading to block 540. At this point, the buyer may be prompted to choose a delivery agency for this transaction only, or for future transactions as well. As an optional feature, this represents an opportunity to lead the buyer to select, as buyer's preferred delivery agency, a delivery agency that the seller has a business relationship with. For example, at block 540, Buyer's client may be connected to a server for a delivery agency. Thus buyer may be presented with information from a delivery agency, and may interact with that delivery agency's system to establish that agency as the buyer's preferred delivery agency. Then, at decision 530, if this Buyer now has a preferred delivery agency, the “Yes” branch is taken, leading to decision 550. At decision 550, if information already has been stored regarding this Buyer's preferred delivery agency, the “Yes” branch is taken, leading to block 570. At block 570, the seller's server may retrieve stored information regarding this Buyer's preferred delivery agency. This allows the seller's server to proceed to block 580, where the Seller's server sends to the server for Buyer's preferred delivery agency some shipping information, shown as “shipping data D”. Shipping data D may include a value of the goods for insurance purposes, package weight and dimensions, time and place for pick-up, and an identifier of the goods. An order number or a tracking number are examples of an identifier. On the other hand, at decision 550, if information has not been stored regarding this Buyer's preferred delivery agency, the “No” branch is taken, leading to block 560. At block 560 there is an opportunity for the seller's server to receive and store information regarding this Buyer's preferred delivery agency. At this point, the buyer may be prompted to enter information, which the seller's server may receive and store for future use. Next, at block 580, the Seller's server sends to the server for Buyer's preferred delivery agency some shipping information, shown as “shipping data D”, as described above. This transmission of shipping data D allows Buyer's preferred delivery agency to pick up and transport goods from Seller to Buyer, as shown in FIG. 4, and the process terminates.

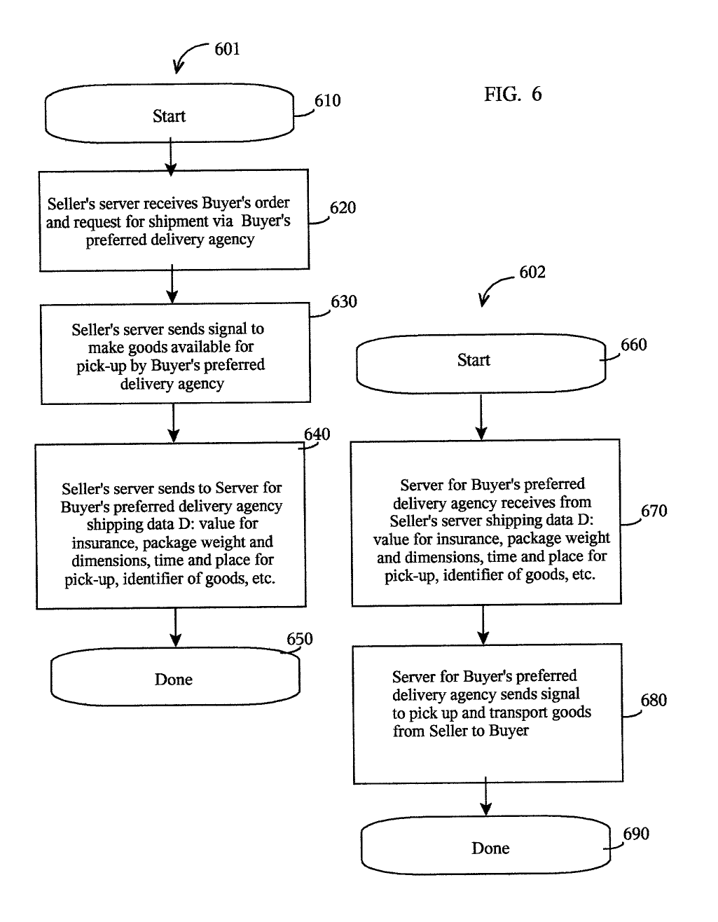

FIG. 6 is a flow chart illustrating examples of two related processes, 601 and 602, that may run on two computers coupled by a communications network. Process 601, which may run on a seller's server, starts at block 610. At block 620, the Seller's server receives a Buyer's order for goods, and a request for shipment of the goods via the Buyer's preferred delivery agency. At this point, the seller's server may receive or retrieve information about the Buyer's preferred delivery agency. At block 630, the Seller's server sends a signal to make the goods available for pick-up by the Buyer's preferred delivery agency. For example, this signal may relay information about the Buyer's preferred delivery agency, and may be sent through a network to a warehouse where the goods are stored. The warehouse might belong to the seller, to a supplier, or to some other entity. At block 640, the Seller's server sends to the server for the Buyer's preferred delivery agency some shipping information, shown as “shipping data D”, as described above. This transmission of shipping data D allows the Buyer's preferred delivery agency to pick up and transport goods from Seller to Buyer, as shown in FIG. 4, and the process terminates at block 650.

Process 602, which may run on a delivery agency's server, starts at block 660, which may represent the initiation of communications between the seller's server and the server for Buyer's preferred delivery agency. At block 670, the server for Buyer's preferred delivery agency receives from the seller's server some shipping information, shown as “shipping data D”, as described above. At block 680, the server for Buyer's preferred delivery agency sends a signal to pick up and transport goods from Seller to Buyer. For example, this signal may relay shipping data D, and may be sent through a dispatching network to a truck driver. This transmission of a signal allows Buyer's preferred delivery agency to pick up and transport goods from Seller to Buyer, as shown in FIG. ⁴, and the process terminates at block 690.

One of the preferred implementations of the invention is an application, namely a set of instructions (program code) in a code module which may, for example, be resident in the random access memory of a computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer-usable medium having computer-executable instructions for use in a computer. In addition, although the various methods described are conveniently implemented in a general-purpose computer selectively activated or reconfigured by software, one of ordinary skill in the art would also recognize that such methods may be carried out in hardware, in firmware, or in more specialized apparatus constructed to perform the required method steps. For example, a wireless communications device could be used as a client device in place of a general-purpose computer.

While the invention has been shown and described with reference to particular embodiments thereof, it will be understood by those skilled in the art that the foregoing and other changes in form and detail may be made therein without departing from the spirit and scope of the invention. The appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the appended claims may contain the introductory phrases “at least one” or “one or more” to introduce claim elements. However, the use of such phrases should not be construed to imply that the introduction of a claim element by indefinite articles such as “a” or “an” limits any particular claim containing such introduced claim element to inventions containing only one such element, even when the same claim includes the introductory phrases “at least one” or “one or more” and indefinite articles such as “a” or “an;” the same holds true for the use in the claims of definite articles.

We claim:

1. A method for selling and arranging shipment of goods, using a network, said method comprising:
receiving from a buyer an order to buy said goods;
presenting to said buyer a buyer-preferred delivery option; and in response to said buyer selecting said buyer-preferred delivery option, making said goods available for pick-up by said buyer's preferred delivery agency.

2. The method of claim 1, further comprising:
communicating, to said buyer's preferred delivery agency, shipping information regarding said goods, wherein said shipping information includes an identifier of said goods, and a time and a place for pick-up of said goods by said buyer's preferred delivery agency.

3. The method of claim 1, further comprising:
communicating, to said buyer, shipping information regarding said goods, wherein:
said shipping information includes an identifier of said goods, and a time and a place for pick-up of said goods by said buyer's preferred delivery agency; and
said buyer sends said shipping information to said buyer's preferred delivery agency.

4. The method of claim 1, further comprising:
communicating to said buyer the price of said goods, without added shipping costs.

5. The method of claim 1, further comprising:
communicating to said buyer information to lead said buyer to select a certain delivery agency as said buyer's preferred delivery agency.

6. The method of claim 1, further comprising:
retrieving additional information, previously stored, regarding said buyer's preferred delivery agency.

7. A method for buying and arranging shipment of goods, using a network, said method comprising:
sending an order for said goods to a seller, wherein said order specifies a buyer-preferred delivery option;
in response to a request from said seller, sending data regarding a buyer's preferred delivery agency to said seller;
sending payment information to said buyer's preferred delivery agency, to arrange said buyer's payment to said buyer's preferred delivery agency;
receiving shipping information from said seller; and
sending said shipping information to said buyer's preferred delivery agency, wherein said buyer's preferred delivery agency uses said shipping information to arrange to pick up said goods from said seller.

8. A method for buying and arranging shipment of goods, using a network, said method comprising:
sending an order for said goods to a seller, wherein said order specifies a buyer-preferred delivery option;
in response to a request from said seller, sending data regarding a buyer's preferred delivery agency to said seller; and sending payment information to said buyer's preferred delivery agency, to arrange said buyer's payment to said buyer's preferred delivery agency;
wherein:
said seller sends shipping information to said buyer's preferred delivery agency; and
said buyer's preferred delivery agency uses said shipping information to arrange to pick up said goods from said seller.

9. A method for arranging shipment of goods purchased from a seller, said method comprising:
providing a first computer in communication with a communications network;
inputting into said first computer an order from a buyer to buy said goods, along with a request for shipment of said goods to said buyer via said buyer's preferred delivery agency;
transmitting from said first computer, over said communications network, shipping information regarding said goods, said shipping information including an identifier of said goods, and a time and a place for pick-up of said goods by said buyer's preferred delivery agency;
providing a second computer in communication with said communications network;
receiving, via said second computer and said communications network, said shipping information; and
transmitting a signal, from said second computer, to direct the transportation of said goods to said buyer via said buyer's preferred delivery agency, based on said shipping information.

10. The method of claim 9, further comprising: receiving, via said second computer, information to arrange payment of shipping costs by said buyer to said buyer's preferred delivery agency.

11. The method of claim 9, further comprising: transmitting a signal, from said first computer, to make said goods available for pick-up by said buyer's preferred delivery agency.

12. A system for arranging shipment of goods purchased from a seller, said system comprising:
a first computer in communication with a communications network; means for inputting into said first computer an order from a buyer to buy said goods, along with a request for shipment of said goods to said buyer via said buyer's preferred delivery agency;
means for transmitting from said first computer, over said communications network, shipping information regarding said goods, said shipping information including an identifier of said goods, and a time and a place for pick-up of said goods by said buyer's preferred delivery agency;
a second computer in communication with said communications network;
means for receiving, via said second computer and said communications network, said shipping information; and means for transmitting a signal, from said second computer, to direct the transportation of said goods to said buyer via said buyer's preferred delivery agency, based on said shipping information.

13. The system of claim 12, further comprising:
means for receiving, via said second computer, information to arrange payment of shipping costs by said buyer to said buyer's preferred delivery agency.

14. The system of claim 12, further comprising:
means for transmitting a signal, from said first computer, to make said goods available for pick-up by said buyer's preferred delivery agency.

15. A computer-usable medium having computer-executable instructions for arranging shipment of goods, using a first computer and a second computer in communication with a communications network, said computer-executable instructions comprising:
means for inputting into said first computer an order from a buyer to buy said goods, along with a request for shipment of said goods to said buyer via said buyer's preferred delivery agency;
means for transmitting from said first computer, over said communications network, shipping information regarding said goods, said shipping information including an identifier of said goods, and a time and a place for pick-up of said goods by said buyer's preferred delivery agency;
means for receiving, via said second computer and said communications network, said shipping information; and
means for transmitting a signal, from said second computer, to direct the transportation of said goods to said buyer via said buyer's preferred delivery agency, based on said shipping information.

16. The computer-usable medium of claim 15, further comprising:
means for receiving, via said second computer, information to arrange payment of shipping costs by said buyer to said buyer's preferred delivery agency.

17. The computer-usable medium of claim 15, further comprising:
means for transmitting a signal, from said first computer, to make said goods available for pick-up by said buyer's preferred delivery agency.
